(19) United States
(12) Patent Application Publication
(10) Pub. No.: US 2004/0153481 A1
(43) Pub. Date: Aug. 5, 2004

(54) Method and system for effective utilization of data storage capacity

(76) Inventor: Srikrishna Talluri, Southfield, MI (US)

Correspondence Address: SRIKRISHNA TALLURI, 23730 POND ROAD, # 121, SOUTHFIELD, MI, 48034, US

(21) Appl. No.: 10/762,839

(22) Filed: Jan. 21, 2004

Related U.S. Application Data
(60) Provisional application No. 60/441,418, filed on Jan. 21, 2003.

(51) Int. Cl. G06F 17/30

(52) U.S. Cl. 707/200

(57) ABSTRACT

A method and system for effective utilization of data storage capacity on storage resources of a communicatively coupled network system involves the creation of a data storage architecture that provides for a dynamic, percentage based segmentation of ‘total installed capacity’ or ‘available/unused storage capacity’ on all or selected nodes on the network system into dedicated and shared storage segments. The storage architecture also employs a centralized file server directly in the path of a distributed network file system in the preferred operating mode, where the centralized server acts uniquely as a host of original data and also as a back-up device.

### CROSS-REFERENCE TO RELATED APPLICATIONS

This application claims the benefit of priority of U.S. Provisional Patent Application Serial No. 60/441,418, filed Jan. 21, 2003 and entitled “METHOD AND SYSTEM FOR EFFECTIVE UTILIZATION OF DATA STORAGE CAPACITY”, the subject matter of which is hereby incorporated by reference herein.

### TECHNICAL FIELD

This invention relates generally to storage architectures of data processing systems and, more specifically, a method for effective utilization of data storage capacity on storage resources of a communicatively coupled network system.

### BACKGROUND OF THE INVENTION

Several large-scale data processing systems are often structured to utilize a multiplicity, also referred to as a cluster, of independent computing entities or ‘nodes’. A node may be a computer, repeater, a file server or other similar peripheral device used to create, receive or repeat a message. A simpler example of a node is a computer system on which one or more processes or threads may execute concurrently. In such distributed computing environments, nodes are typically communicatively coupled, via a network, to allow processes on any given node to access resources on other nodes. The hardware and software resources of these nodes are generally managed by a complex piece of software called an operating system. In this context, hardware resources are generally processors, storage media (such as disk drives, memory) and devices such as printers, scanners etc. while software resources generally encompass a set or multiple sets of data and/or routines.

Further, in such distributed systems, some of the nodes may be used to handle and store a set or multiple sets of data files. Such file serving nodes maybe a single file server or a collection of file servers.

### Data Availability

For several businesses particularly those that deal with consumer accounts such as banks, stockbrokers, credit card companies etc. the success and often the very existence of the business depends on the availability of data at all times. Such businesses are even mandated by regulations to provide high data availability. To ensure such a high level of availability, it is vital to protect against data loss that might occur due to the failure of one or several nodes on the network and other reasons. In this regard, administrators of computing resources have long been charged with the responsibility of periodically backing-up critical data onto removable media such as tape and securing a copy of the same at an alternate location.

This traditional backup practice has been further extended and enhanced to cover all data that is backed-up, usage of newer media such as optical disks, automation of backup processes and/or by making multiple backup copies of the data.

The inadequacies in the reliability of nodes and the communication network are mitigated by strong back-up storage strategies that take into account resource malfunctions due to intrinsic breakdowns, malicious computer attacks and geographic vulnerabilities (such as susceptibility of the location to natural disasters) among others. Such a strategy involves making multiple redundant copies of a particular piece of data. This generally translates to replicating the data and keeping a copy of the same, on-site and yet another copy at a remote location (generally not on the same geographic fault line). The on-site backup copy aids in the quick restoration of services. On the other hand, the remote/off-site copy facilitates for a rebuilding of services at the original service facility, in the event of the on-site backup copy being unusable or in creating an alternate service facility when the original service facility is itself unusable or inaccessible.

For a long time, tape media has been the preferred media for data backups and different tape media technologies such as DLT, LTO, SDLT, AIT etc. have been used. However, of late, there has been a notable shift towards using disk medium even for backup (particularly on-site backup) as it offers several advantages such as quicker restoration of data when the backup copy is stored on disk, as compared to tape media. As such, storage servers (with disk arrays) dedicated to taking and hosting backup copies of data (on-site) have now become commonplace.

Depending on the critical nature of the data, the organization of the network and storage systems and the amount of data being backed up etc.—there exist several backup methodologies for making such on-site and off-site copies. These include snapshots, disk mirroring, synchronous remote copying, asynchronous remote copying etc.

Most of the current backup methodologies, however, involve additional infrastructure investments in terms of the media used for data backup, while a whole lot of existing, usable media remains untapped for such purposes. Further, these methodologies often include potentially disruptive, expensive and time-consuming practices such as the physical reallocation of storage space, server and network reconfiguration, storage device reconfiguration etc.

### Storage Capacity Utilization

In any computing environment, it is desirable to effectively use the existing hardware and software resources before making additional infrastructure investments. Large corporations, universities etc. normally tend to have network infrastructures with multiple, heterogeneous servers and decentralized data. These servers are often chosen by or within specific departments for their specific advantages in tackling particular problems. For instance, Unix servers are known for handling complex design and engineering assignments while certain other servers offer superior random file access characteristics (for database applications). It naturally follows that there would be installed storage capacity on these servers and on their individual clients and independent disks/storage media under the control of the particular server, hereinafter referred to as a ‘Server Group’ (SG). However, with traditional methods, additional storage capacity is installed when required for a particular server (for example, when data stored on a node is reaching or has reached critical maximum levels) while a large amount of such data storage capacity that already exists on other server groups (SG), on the network, may remain untapped. This represents an unnecessary expenditure for the enterprise as a whole, which may also involve additional unnecessary work assignments such as requesting quotations from vendors, vendor/product evaluation, commissioning of new equipment etc. for the enterprise's technical and purchasing departments. Further, the inability to seamlessly allocate storage capacity among different departments as a ratio of total installed capacity or unused storage capacity inhibits planning/implementation of an organization wide storage segmentation policy and true utilization of organization wide data storage resources.

The following example further illustrates this point. Example: The Production department of a manufacturing firm uses five nodes (server or server cluster) with an installed capacity of a hundred storage units, but an actual usage of only fifty storage units. The finance department uses two nodes with forty storage units and actual usage of only twenty storage units. Finally, the sales department uses three nodes with thirty storage units and current usage of twenty storage units. Further, all departments' resources are coupled together by a network. During instances, when the sales department receives a sudden influx of orders for a new device manufactured by the firm, it would be ideal to use a certain portion of the excess unused/installed storage capacity in the production and/or finance departments to spillover excess data beyond the installed capacity for the specific Sales department. In an analogous situation, the production department needs to store equipment blueprints for new equipment being installed, the layout plan of a new production line and also store employee work schedules. When storage capacity utilization is nearing the maximum data storage capacity installed on the nodes of this department, it would be useful for the production department to be able to tap into the unused storage capacity available on nodes in other departments. This would give the organization the ability to handle sudden increases in data storage capacity, crucial time to plan and implement the exact amount of additional data resources, increase efficiency (by increased utilization) of existing resources and an increased ROI (return on investment) on their data storage resources while preventing avoidable additional capital investments.

While data storage capacity can currently be segmented during installation of storage media and a predetermined section of data capacity be shared with other nodes, this is done in terms of specific number of actual storage units but not in terms of a ratio or percentage of data capacity. Further, dynamic facilitation of storage capacity (in terms of percentage) to be shared, is also not currently feasible.

This existing methodology of sharing data storage capacity on a particular node puts a limitation on the amount of sharable storage capacity in terms of predetermined actual storage units and at the same time, it also places the burden (on the specific departments—in the above example) of planning and determining beforehand, the amount of total storage capacity that can be committed to such sharing, in terms of actual storage units.

As such, it is desirable to be able to install a storage policy, where a percentage of the storage capacity (either total storage capacity or unused storage capacity) on a server group (SG) or on a particular node may be shared globally with other resources on the network, on the fly, while a percentage of the same is dedicated solely to that particular server group (SG) or particular node. Such a policy provides an avenue for determining sharable data storage capacity, at any time, in terms of ‘available/unused or total’ capacity rather than just ‘total’ installed capacity and ensures efficient storage capacity utilization by storing data pertaining to a particular node (when data storage capacity for this node has been used) on a collection of other nodes on the network, thereby tapping into the unused data storage capacity and increasing the ROI (return on investment) for the enterprise as a whole.

Another example of a beneficiary of such a storage policy would be an ‘application services provider’ (ASP) where storage requirements and usage rapidly fluctuate. Consider such a company whose primary business is offering managed web-hosting services for their clients, who lease dedicated servers owned and managed by the company (service provider). Beyond a web presence, the clients' websites are further designed to accept customer data and sales orders for their merchandise/services. Such information is stored in databases on the servers. During instances when the data stored on a particular dedicated server is approaching the maximum available capacity (including the capacity on any direct attached storage system that may be connected to and made available to the server) and when the server cannot be taken down (as that would lead to an interruption of business activity)—the ability to seamlessly segment available data storage capacity on other servers (or server groups (SG)) and use a percentage of the same for storing data from this particular server would be a very potent option for the service provider. This may be done temporarily, until additional data storage resources are installed on this particular server or as a policy across all dedicated servers being managed by the service provider.

The examples defined in this section may be extended to include the concept of a storage area network (SAN), which is essentially a server group (SG), on a larger scale. In the scenario of a network of storage area networks (SANs) existing in an enterprise (where, for example, each department of the enterprise has its own SAN) the seamless data segmentation, tapping of storage resources etc. may be carried out across the network of SANs.

### Types Of File Systems

Most of the file systems can be categorized into three types: centralized, distributed and serverless. In a centralized file server system, a dedicated node handles all file operations with low data integrity issues. However, the server becomes a potential threat as a single point of failure and lacks scalability.

In a distributed server environment a set of nodes share the workload of the traditional centralized file server. For example, The Zebra Striped Network File System (Hartman et al 1995) describes a striped network file system that batches small files together into sequential log, divides the log into larger, efficient stripes and writes these stripes to all the servers. Zebra uses a central file manager to manage directory and file attributes, supervise interactions between clients, maintain clients' cache consistency etc. While the file manager does not store file data, clients must contact the file manager on each open and close, thus, bringing in an additional step in the data access/storage process. The striping of each segment to all the storage servers limits the maximum number of storage servers that Zebra can efficiently use, thereby, limiting its efficiency. Zebra is also not optimized to run database applications that tend to update and read large files randomly. Finally, Zebra uses up one storage server for storing parity and cannot sustain multiple server failures.

In a serverless environment, the functions of the traditional centralized server are distributed amongst all clients and storage devices. For example, The Serverless Network File System (Anderson et al 1996) batches small files together into a sequential log, divides the log into larger efficient stripes akin to Zebra, but writes the stripes to a limited number of servers called stripe groups. Multiple stripe groups spanning different sets of servers exist on the system. While this gives more scalability to the file system, it still cannot survive failure of more than one server in a single stripe group. File resource information is created and copies of the file resource information for all files are distributed to each of the servers in the striped file system. The file resource information for all files is stored in four key maps—manager map, imap, file directories and stripe group map (using file index numbers) and these maps are globally replicated into the memory of each server. The replication and consistency maintenance across copies of such maps entails writing and updating file resource information for each map at each location for every change and incurs substantial file system overhead.

Other types of file systems include, The Swarm Scalable Storage System (Hartman et al 1999), which describes a simplified storage system where data is batched together into logs, as in the above example, and striped across a limited number of servers or network-attached storage devices, referred to as a stripe group. Here data written by clients onto the network-attached storage devices is not synchronized among themselves. Such a system while it provides better scalability cannot survive the failure of more than one device in the same stripe group.

It is evident from the above examples that the centralized file server system, in addition to being a potential single point of failure, does not make use of additional storage capacity that might be installed elsewhere on the network. While the distributed and serverless network file systems spread the risk of failure and use the installed storage capacity more effectively, redundancy still has to be incorporated (in all types of file systems) to effectively prevent catastrophic loss due to single or multiple server failure and provide high availability. Further, the distributed and serverless network file systems do not take network and I/O (input/output) subsystem bandwidth usage into consideration, which means that these systems could further clog the network bandwidth and/or overload the I/O subsystem on the nodes, thereby detrimentally affecting the performance of the node for other intrinsic operations.

### SUMMARY OF THE INVENTION

Accordingly, it is an object of the present invention to provide a storage architecture of a data processing system that effectively utilizes existing data storage capacity.

Another object of the present invention is to provide a storage architecture of a data processing system that allows dynamic configuration of storage capacity and segmentation into dedicated and sharable storage capacity in the computing environment from a single console.

Yet another object of the invention is to provide a storage architecture of a data processing system that uses a centralized file server directly in the data path of a distributed network file system.

Still yet another object of the invention is to provide a storage architecture of a data processing system that takes network and I/O subsystem bandwidth usage into consideration for storing data in a distributed network file system.

Still yet another object of the invention is to provide a storage architecture of a data processing system that provides high data availability by reducing the effects of system failures through computed parity and multiple levels of redundancy.

Specifically, the present invention provides a novel, scalable network file system that uses multiple servers, individual clients, storage devices and a collection of inexpensive disks to effectively and optimally utilize existing storage resources, provides for high data availability, high system performance and greater protection against data loss while replicating data and simultaneously taking network bandwidth and I/O subsystem usage limitations into consideration.

### BRIEF DESCRIPTION OF THE DRAWINGS

FIG. 1 is a block diagram of a network of communication interconnections of a multi-node parallel computing system.

FIGS. 2A, 2B and 2C are block diagrams illustrating prior art methods of distributed file systems

FIG. 3 is a block diagram illustrating a Server Group.

FIG. 4 is a block diagram illustrating a method of organizing file resource information across nodes in accordance with the present invention.

FIG. 5 is a flowchart illustrating the sequence of steps involved for servicing a storage segmentation transaction in accordance with the present invention

FIG. 6 is a flowchart illustrating the sequence of steps involved for servicing an I/O write transaction in accordance with the present invention

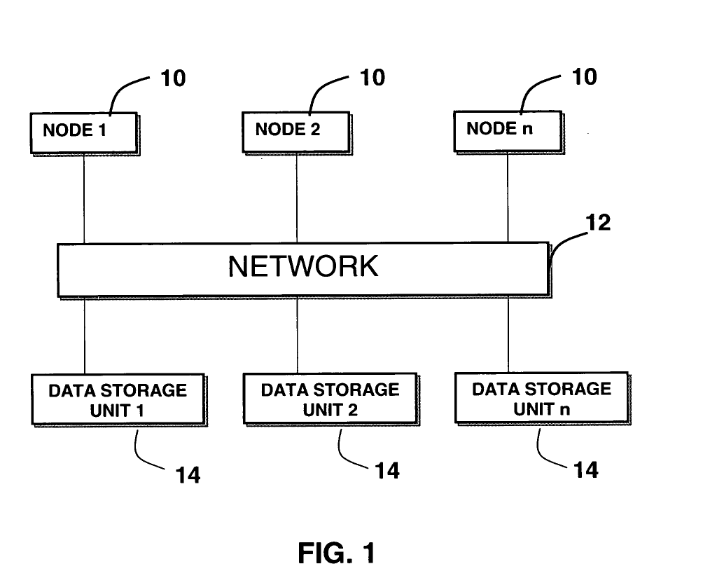

Referring to FIG. 1, which is a block diagram of a distributed computing system and comprises a number of nodes 10, and a number of data storage units 14 all interconnected via a high-speed network 12.

Each node 10 is an independent computer system interacting with other nodes 14 through the communication network 12. The data storage unit nodes may be a single file server or a collection of file servers. It is understood by those skilled in the art that a distributed data storage unit node can be defined as a software based process that may occur in programming environments or can be a physical computer system.

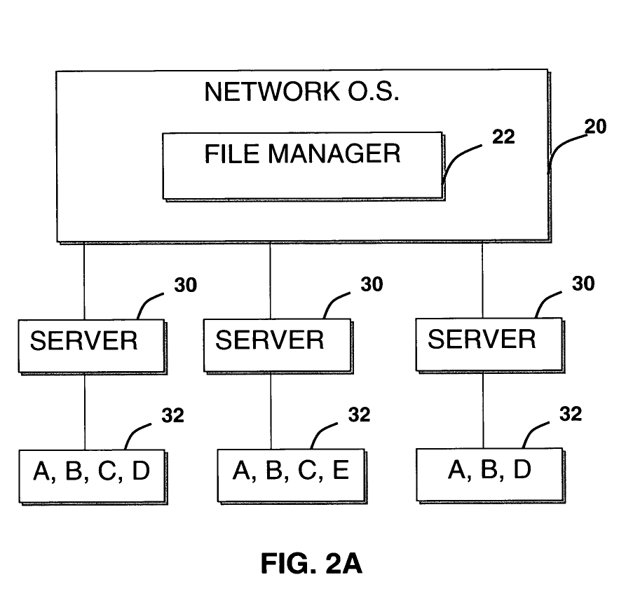

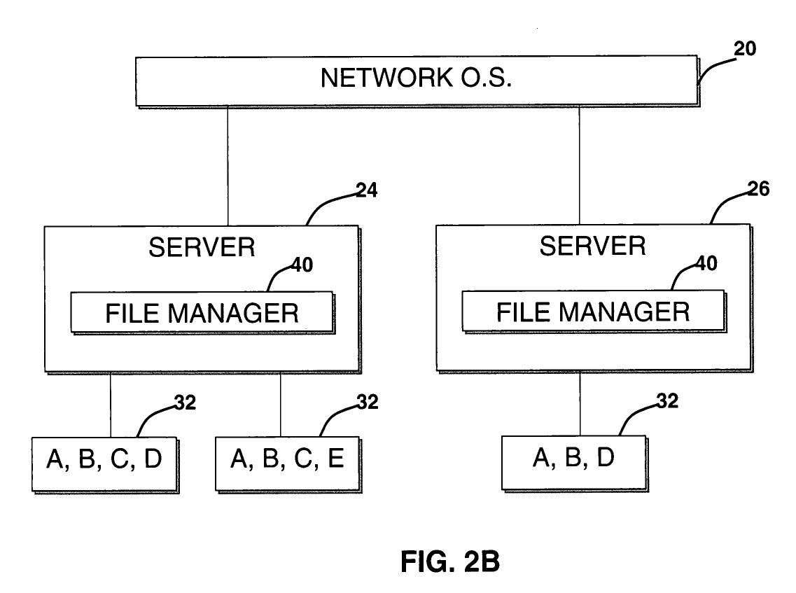

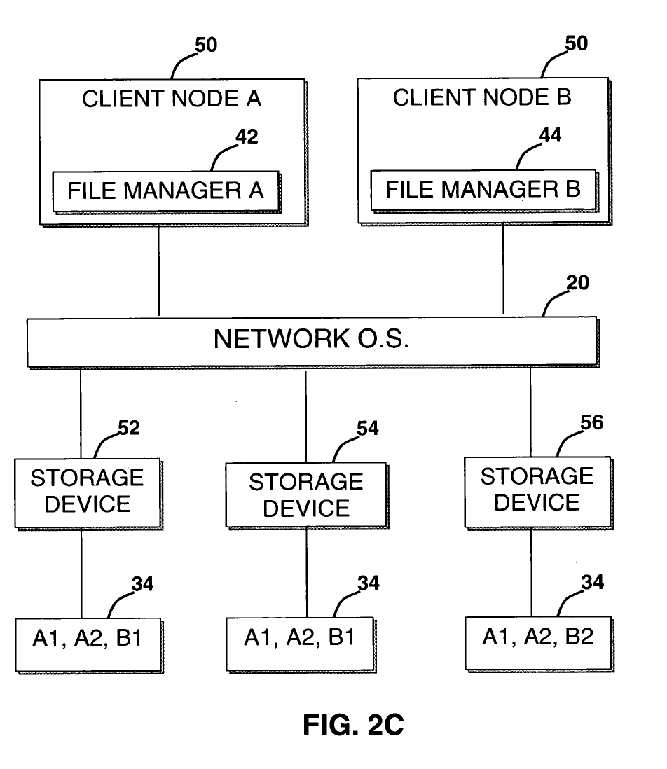

FIG. 2A is a block diagram of a prior art example showing files striped across multiple servers with a centralized network file manager, an example of which is the Zebra file system. File resource information for all files is organized in a single network file manager 22, which is implemented and operates in network software, i.e. the network operating system 20. Here, each server node 30 is connected to a single data storage system 32 (disks in this case), which is divided into stored file blocks labeled according to the file (A, B, C, D, E) from which it originated. Files A and B each include three file blocks with each of the blocks stored on a different server node. Files C and D include two file blocks with each of the file blocks stored on a different server. File E has a single file block stored on a single server. The centralized file manger 22 handles management of file resource information for all files.

FIG. 2B is a block diagram of a prior art example showing files A, B, C, D and E striped across multiple servers with file managers 40 operating at the server level, an example of which is the Serverless file system. Files A, B, C, D and E are striped across two server nodes, a first server node 24 and a second server node 26. The first server node includes a server file manager 40 and a plurality of disks 32. The server file manager 40 organizes file resources information for all files stored across all servers 24, 26 at the server level. Here, file blocks for files A and B are stored on two different disks within server node 24 and on a single disk in server node 26. File blocks for file C are stored on two different disks on server node 24. File blocks for file D are stored on a disk in each of the server nodes 24, 26 and file blocks for file E are stored on a single disk on node 24. The mapping of file blocks to disk blocks is replicated on both node 24 and node 26.

FIG. 2C is a block diagram of a prior art example showing files striped across a group of multiple servers with no synchronization between servers, an example of which is the Swarm storage system. Client nodes 50 are connected to multiple network-attached storage devices 52, 54, 56 via a network. In this example, files A1 and A2 originate from client node A and files B1 and B2 originated from client node B. The disks 34 on the network-attached storage devices 52, 54, 56 contain stored file blocks labeled according to the file from which it originated. Files A1 and A2 have two file blocks, on the disk of each of the network-attached storage devices 52, 54, 56. File B1 has a file block on the disk of network-attached storage devices 52 and 54. File B2 has a single file block on the disk of network-attached storage device 56. The client file manager 42 maintains a log of all the files that were written by client node A and client file manager 44 maintains a log of all the files written by client node B but the file information is not synchronized between the two client file managers 42, 44.

### DESCRIPTION OF THE ILLUSTRATIVE EMBODIMENT

The illustrative embodiment of the present invention incorporates an innovative, modular architecture that is made up of the following components.

Node manager (NM): A high I/O capacity storage device with multiple I/O channels and processors and scalable data storage capacity, ideally utilizing low cost hard drives.

The node manager is uniquely used as a host of original data and also as a backup repository/device. The Node manager (NM) is a key component of this embodiment. The node manager hosts the controller (C) and interacts with software agents (SA) and also periodically monitors the nodes by the commonly accepted and widely implemented ‘ping’ service to determine their status (whether they are up or down i.e. in working condition or disabled).

Controller (C): The controller consists of a software console that can be accessed through a communications network (generally by the storage administrator) after validation of access privileges. The controller module (C) is typically installed on the node manager (NM). Determination and implementation of storage policies for either specific nodes or all nodes on the network are facilitated from the controller.

Client Nodes (CN): Nodes, coupled to the network, which run application programs.

Storage Server Nodes (SN): Nodes, coupled to the network, which store data.

It should be noted that a node might be a client node (CN) and a storage server node (SN) at the same time.

Software Agents (SA): Applications consisting of a set of defined processes that execute given tasks. Software agents (SA) are installed on all nodes on the network whose storage capacity is to be tapped. The controller (C) and the software agents work on an event driven ‘Push’ technology, where the software agents report any and every change in the installed storage capacity of individual nodes to the controller (C), in real time and also report other data at predefined intervals.

The software agents may also be setup to read filesystem and I/O subsystem capacity and monitor the frequency of their usage. They may further be programmed to read storage capacity used (which helps determine sudden increases in storage requirements). Such information may be programmed to be sent to the controller (C) periodically. Further, the software agents are built-in with a ‘data cleanser’, which is run at specific times to free up space on the hard disk.

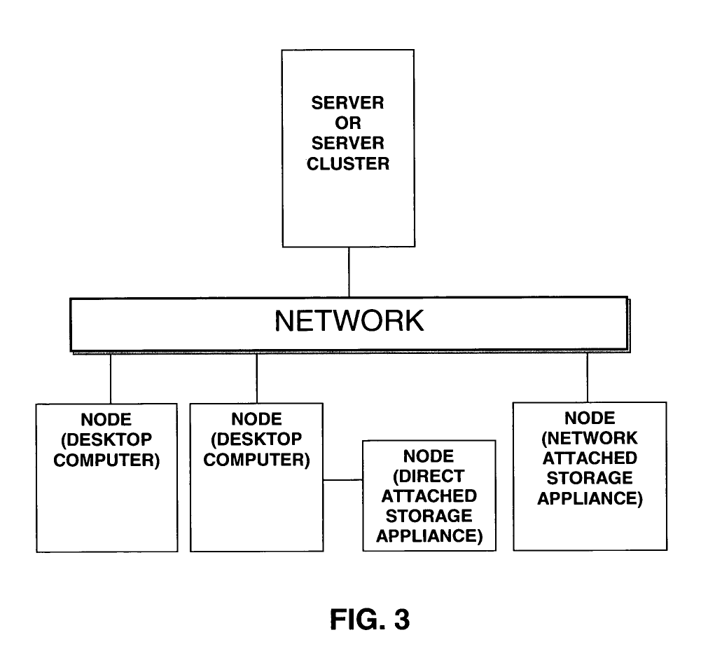

Server Group (SG): A server or set of servers and all its clients (individual computers) and storage devices under the control of the specific server(s). FIG. 3 is an illustrated example of a server group (SG).

This definition of the server group (SG) is used to also incorporate ‘thin-client’ or ‘Mainframe’ like architectures (where the clients do not have application or storage resources of their own, except for minimal memory and other requirements and are used to run programs and store data on the server itself) into the illustrative embodiment.

Nodal Storage (NS): The percentage of storage capacity on nodes that is committed only for that particular node.

If there are nodes that are thin-clients and store data on the server itself or on a dedicated storage device on the network, this definition may be further expanded as—the percentage of storage capacity on nodes that is committed only for that server group (SG) (in case of node being a server or a storage device).

Global Storage (GS): The percentage of storage capacity on nodes that is committed for utilization by all nodes on the network that have been given privileges to utilize this space.

Bandwidth Meters (BM): Devices that are connected to the network to measure bandwidth usage in the network. These bandwidth meters send information to the Node manager (NM) about the network bandwidth usage. They may be configured to send information to the Node manager (NM) only when the network bandwidth usage falls below predetermined thresholds (these thresholds could be instantaneous levels or averaged over time).

Stripe Set (SS): Similar to ‘stripe groups’ in ‘The Serverless Network File System’. A Stripe Set (SS) is a subset of the total number of available storage devices onto which data is fragmented and striped, generally with RAID methodology/computed parity. The storage devices may be storage server nodes (SN) or individual hard disks in a disk array.

The advantage of using only a stripe set (SS) instead of striping the data onto all the existing drives is that it creates leeway for graceful scalability of storage capacity. Through the usage of stripe sets (SS), additional disks may be added to the Node manager (NM) (without disrupting the data that has already been striped) and these new disks become part of another distinct stripe set (SS). Further, writing the data to only a subset of storage devices enables a larger more efficient size of data to be written instead of small, inefficient blocks of data to all of the storage devices. It also enables multiple files to be written at the same time to distinct stripe sets (SS) instead of waiting for a file to be written to all the storage devices before the next one is taken up. Use of stripe sets (SS) (with parity/RAID) protects against data loss by enabling the data to be reconstructed despite the failure of storage device(s).

Description

The present invention optimizes storage capacity utilization by implementing a storage policy that entails taking over a predefined percentage of total or unused storage space on nodes and making it available for other nodes on the network.

The storage policy may include policy decisions such as the percentage of available storage space that is to be committed to global storage (GS) (i.e. either as percentage of total storage capacity on that node or only a portion of the available unused space), whether or not to use computed parity (RAID), whether or not to setup a backup process, type of backup to implement (synchronous, asynchronous etc.), scheduling an optimal time for backup etc. Further, the storage policy itself may also be setup to be dynamically implemented on nodes based on the increasing requirements for storage capacity and also to dynamically modify the percentage of storage segmentation (into nodal storage (NS) and global storage (GS)) based on such criteria.

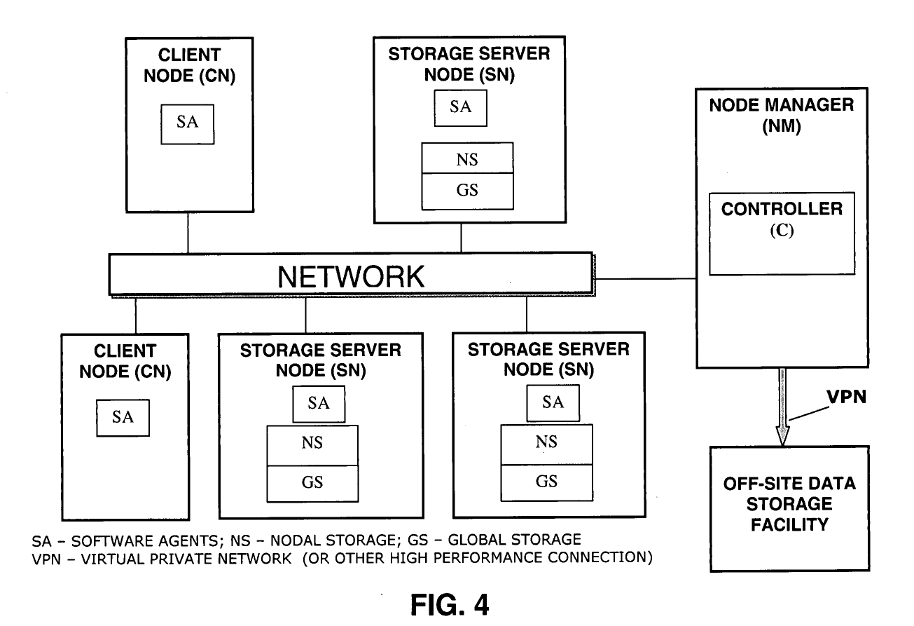

Back-Up Methodologies: As ‘hot backups’ (also known as synchronous backups) generally tend to further clog the network, the administrator is empowered with selecting a backup methodology and scheduling a timeframe for backup. The administrator, therefore, customizes a suitable backup approach taking data criticality, network traffic and other parameters into consideration. In addition, an additional level of redundancy maybe added by sending a copy of the data to a remote, offsite location through a VPN (virtual private network) or similar high performance network connection. FIG. 4 is a block diagram that depicts the illustrative embodiment.

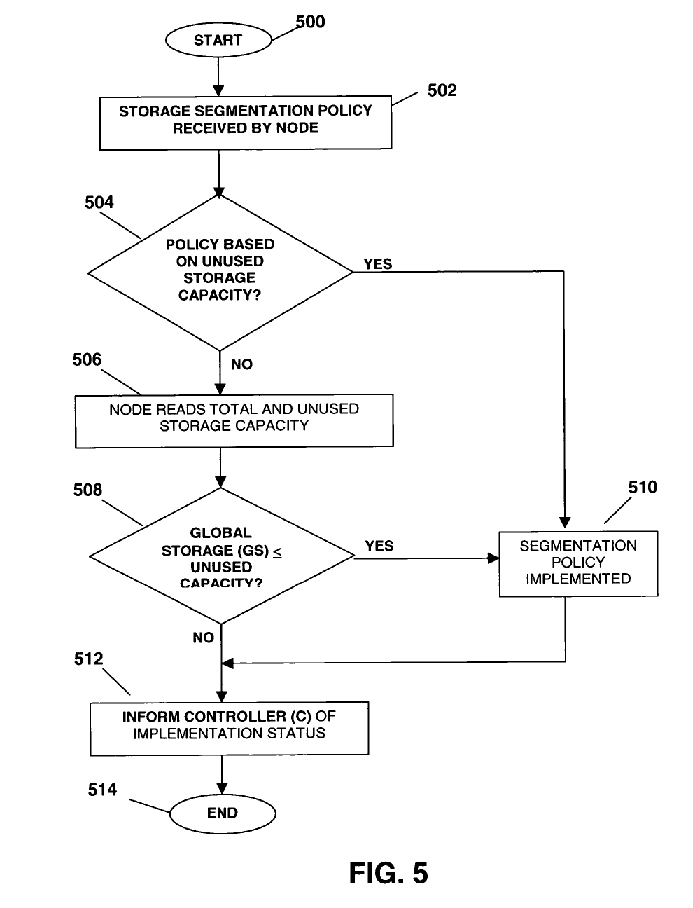

FIG. 5 is a flowchart depicting the sequence of steps for implementing a storage segmentation policy for either specific nodes or all nodes on the network, in accordance with the illustrated embodiment. The sequence starts at step 500 and proceeds to step 502 where the node receives the storage segmentation policy from the controller (C). The policy might be based on either total installed storage capacity or just the unused storage capacity available. In step 504 the node determines if the policy is based on unused storage capacity. If yes, the next step would be step 510, which involves implementation of the storage segmentation policy and designation of that percentage of available storage capacity as global storage (GS). (It is understood that when the storage segmentation policy is based on unused/available data storage capacity, the data storage capacity is in fact available for such configuration/segmentation, irrespective of the percentage (up to 100%) to be segmented). The controller (C) is then informed of the status (successful implementation of the storage segmentation policy) in step 512 and the process concludes in step 514.

If the answer to step 504 were negative, it would imply that the storage segmentation policy is based on the total installed data storage capacity on the node. The next step would then be step 506, where the node reads both the total and unused storage capacity on the node. In step 508, the node determines if the percentage of storage capacity to be segmented and designated as global storage (GS) is in fact available (as unused storage capacity). If yes, the storage segmentation policy is implemented in step 510 and the storage capacity as indicated by the storage segmentation policy is designated as global storage (GS). The controller (C) is then informed of the status in step 512 (successful implementation of the storage segmentation policy) and the process concludes in step 514.

In step 508, if the answer is negative, the process moves on to step 512, where the controller (C) is informed of the status (failure of the storage segmentation policy implementation process) and in this case also passes information about total and unused storage capacity both in terms of percentage and actual storage units.

If the process fails, the controller (C) may instruct the particular nodes to run the ‘data cleanser’ (explained in the next section) and re-try the storage segmentation policy implementation.

Once the decision has been made to effectively utilize storage capacity and the policy has been implemented, storage capacity can now be categorized as nodal storage (NS) and global storage (GS). In fact, global storage may be specifically designated and identified as such (GS), while all the remaining storage capacity may be implicitly considered as nodal storage (NS).

The working structure of the system differs with and without a data backup policy, as described below.

Case I: With (Onsite) Redundancy

Writing Data

For data written to nodal storage (NS) by a node to its local disk (or by a thin-client node to the server or a dedicated storage device on the network), the conventional procedure where the application passes the instructions to the file system and I/O subsystem is followed. Once this data has been written to nodal storage (NS), a replica of the same data is later written to the Node manager (NM)—at a predefined time, based on the backup methodology/policy. It is noteworthy that, in this scenario, the Node manager (NM) acts as a backup repository by storing a replica of the original data.

When the node or server group (SG) is out of nodal storage (NS), the data is now written onto the global storage (GS) of the storage server nodes (SN) in the entire network in a two-step process. Data is in fact first written to and stored on the Node manager (NM). This data is later replicated from the Node manager (NM) onto the global storage (GS) section of a selection of individual storage server nodes (SN), based on the backup policy implemented by the administrator. The Node manager (NM) maintains a metadata system that indicates where on the Node manager (NM) the system has stored each data block and also the specific locations on the storage server nodes (SN) where they have been replicated. In this scenario, the original data from the client nodes (CN) is in fact written to the Node manager (NM). The global storage (GS) of the selected nodes, therefore, actually hosts only the backup copy of data.

The Node manager (NM) uses a high performance write cache to improve file system performance. When data is written to the Node manager (NM) the write cache acknowledges the I/O request and sends a response to the client node (CN) (returns control to the application) without waiting for the data to be written to disk (stored on disk). The Node manager (NM) may further use non-volatile random access memory (NVRAM) to handle file system metadata and reduce disk accesses. To avoid redundancy, the write cache may use the same NVRAM as a cache for storing file system metadata and regular data. This enhances fault-tolerance, file system availability and recovery in the event of a system crash. Moreover, the usage of NVRAM enables the usage of DMA (direct memory access) or similar methodologies (that enable direct transfer of data between memory and disk without the involvement of the processor) to transfer this metadata onto another node or to offsite backup thereby freeing up the processors for other system procedures.

Data that is being backed up from the Node manager (NM) to global storage (GS) is batched together into a sequential log, which is then divided into more efficient larger blocks, the size of which is determined by the Node manager (NM). The controller (C) on the node manager (NM) receives information about the network bandwidth usage from the network bandwidth meters (BM) and information about I/O subsystem capacity and usage of storage server nodes (SN) from the software agents (SA) installed on these nodes. This information is used to determine the optimum batch size of data to be written to the global storage (GS) of storage server nodes (SN), by optimal utilization of network bandwidth and I/O subsystem of storage server nodes (SN), thereby avoiding clogging of the network and straining of the storage server nodes' (SN) system resources, which may happen if data is sent at an inopportune time (for instance, when the storage server nodes' (SN) file system resources are already severely strained). This information may also be used to define peak usage times and off-peak usage times and to determine a suitable time for the back-up process.

This data may be backed up with or without parity on the global storage (GS) of storage server nodes (SN). From the above description, it is understood that the storage capacity on the node manager (NM) would always have to be more than the storage capacity on all the storage server nodes (SN), combined—as the node manager (NM) would have to store as much data as can be stored on all the storage server nodes (SN) whose storage resources are being tapped and the file system metadata on the node manager (NM) itself. It follows that the data storage capacity on the node manager (NM) would have to be increased when additional storage resources are being tapped in line with such a storage policy.

DATA TRANSFER: File or block level data transfer: The data that is written by the nodes to the Node manager (NM) and then by the Node manager (NM) to the global storage (GS) on the storage server nodes (SN) can be written either at a file level or at a block level (a block is a collection of data from a file).

PARITY: The data that is written to the Node manager (NM) may further be written with parity (RAID) or without parity. Computed parity/RAID methodology is used to protect against data loss by enabling the data to be reconstructed despite the failure of storage device(s). Using parity at this stage provides another level of precaution against data loss and provides higher data availability. When written with parity, the data that is sent to Node manager (NM) is evenly fragmented and striped only onto a subset of drives installed on the Node manager (NM), referred to as a stripe set (SS). If RAID is implemented on the node manager (NM), data written by the client nodes (CN) to the Node manager (NM) are batched together by the Node manager (NM), fragmented and striped onto distinct stripe sets (SS) in optimal size data blocks to increase efficiency. This operation of batching together data written by client nodes (CN) and segmenting the same into fragments may be handled by the NVRAM of the Node manager (NM).

Similarly, data being written by the node manager (NM) to the global storage (GS) of storage server nodes (SN) may also be written with parity. In this case, the data is written only to a subset (stripe set (SS)) of available storage server nodes (SN).

DATA SECURITY: All data that is written to the Node manager (NM) and the global storage (GS) of storage server nodes (SN) is identified with a file ID which includes information about the client writing the data, a security identifier which determines access restrictions etc. A complete log of all transactions is recorded to ensure business continuity.

Reading Data

For data that is stored on the nodal storage (NS) section of a node, the file is opened and closed in just the same way as accessing a file on local disk. Any changes made to the files on nodal storage (NS) are later copied onto the Node manager (NM).

For files that were written to the global storage (GS) section of storage server nodes (SN), it must be noted that the original data written by the client nodes (CN) is in fact hosted on the Node manager (NM) and the global storage (GS) only holds a replica of the same. All data that is written by the client nodes (CN) to the Node manager (NM) appears as a local file on the client node (CN). However, a pointer is placed from the file on the client node (CN) to the node manager's (NM) metadata system for this particular file. When a user on the client node (CN) tries to open this file, the pointer contacts the Node manager (NM) where the request for the file is checked with the security ID stored in the file ID (for this specific file/block of data) and the file is presented to the client node (CN) upon validation of file access privileges. Any changes made by the client nodes (CN) to this copy are stored and later incorporated in the copy of the same (stored on global storage (GS) section of storage server nodes (SN)).

CACHE CONSISTENCY: When file data are accessible by multiple client nodes (CN) at the same time and cached by the client nodes (CN), there is the potential that one client node (CN) may write to and thereby update a particular file when the same file is being read by another client node (CN). Different approaches may be taken to address this situation, which include an optimistic approach of assuming that a client node (CN) will not update a file when it is being read by another client node (CN) or a pessimistic approach where the client node (CN) reading a file that has just been updated (by another client node (CN)) must discard its cached file data and fetch the updated one. The present invention provides an avenue for the selection of a suitable approach but leaves the determination of which approach to be followed to the users of the client nodes (CN).

From the above, it is evident that the node manager (NM) has the uniqueness of acting as a back-up device (by hosting copies of data that were written by different nodes to their nodal storage (NS)) and also acts as a host of original files (by hosting the actual files/data that were committed by different nodes to the global storage (GS) of nodes on the network).

Data Cleaning

When data is read and updated, it often leads to the removal of blocks of data, leaving unused, empty spaces or ‘holes’ that contain no data. Irrespective of whether RAID methodology/Computed parity is used, the removal of these ‘holes’ both on the node manager (NM) and the individual storage server nodes (SN) are necessary to improve system performance. A ‘data cleanser’—an application that is similar to a disk defragmentation process, achieves this purpose. For the storage server nodes (SN), the data cleanser may be built into the software agents (SA) and invoked either at predetermined times—when the node is expected to be idle, when the node is actually relatively idle or when a storage segmentation policy is being implemented on that node etc.

For the node manager (NM), the data cleanser may be built into the controller (C) or as an independent application. The actual invocation of the data cleansing operation on the node manager (NM) may be scheduled at intervals of a specific number of read-write operations, at a predetermined time or other such parameters.

Operation

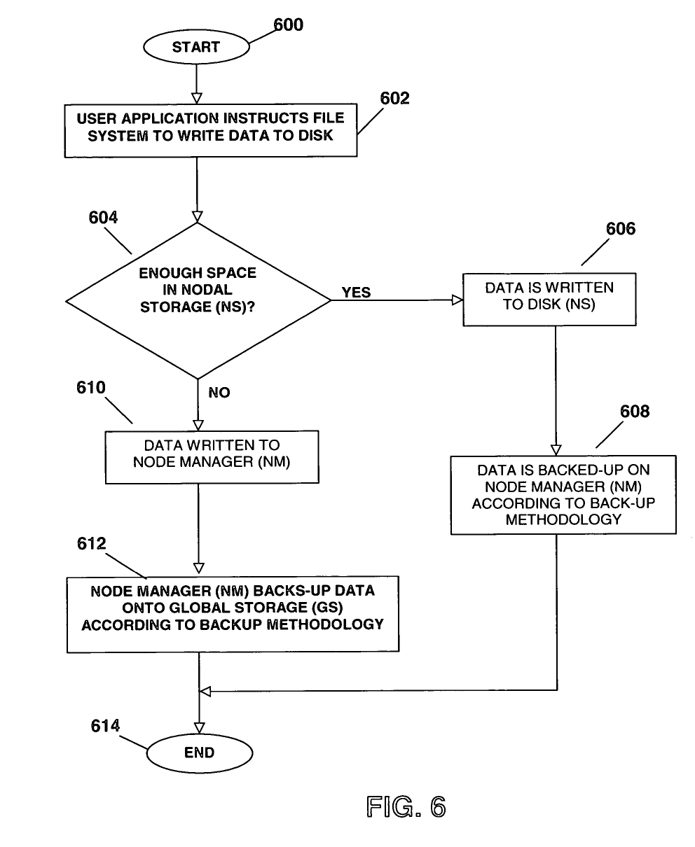

FIG. 6 is a flowchart depicting the sequence of steps for writing and backing-up data in accordance with the illustrated embodiment. The sequence starts at step 600 and proceeds to step 602 where an I/O transaction, such as a write transaction is issued by the user application to the file system. Step 604 examines if there is sufficient nodal storage (NS) to which the data can be written. If the nodal storage (NS) is sufficient for the data to be written, data is written to disk in step 606. The data is backed up on the node manager (NM) in step 608 and the transaction completes in step 614.

If the nodal storage (NS) is insufficient for the data to be written, the data is then sent to and written on the node manager (NM) in step 610. The node manager (NM) later backs-up the data onto the global store (GS) section of selected storage server nodes (SN) in step 612, which completes the transaction in step 614.

Case II: Without Onsite Redundancy

The embodiment described thus far can be modified for scenarios/network architectures that do not utilize a centralized file server/storage device for onsite backup (i.e. without the node manager (NM)). The controller (C) can now be installed on any node and manages the file system metadata, the implementation of the storage segmentation policy (configuration and segmentation of data storage capacity on nodes into nodal storage (NS) and global storage (GS) sections), implementation of the off-site backup policy, assimilation of information from software agents (SA) etc.

When a node is out of nodal space, data to be written is now striped onto a stripe set (SS) of global storage (GS) sections on individual storage server nodes (SN). The controller (C) actually determines the stripe set (SS) onto whose global storage (GS) sections this data is to be actually written. The controller (C) passes this stripe set (SS) information to the nodes, when contacted by the nodes prior to writing the data to global storage (GS). The controller simultaneously records a log of all transactions for business continuity purposes.

While storing data in this scenario (without onsite redundancy) might appear similar to peer-to-peer storage—a method of storing data on other nodes on the network, the primary difference and big advantage of the present embodiment is the ability to dynamically and seamlessly segment storage capacity either in terms of actual or unused data capacity. Such segmentation takes into account the interests of both the specific entity within an organization as well as the organization's goals itself into consideration by providing direct owners of storage resources (for example: a specific department in an enterprise) an assurance that a certain percentage of storage capacity (in the specific department) will always be available for their specific usage (irrespective of the changes in the amount of installed data storage capacity in the department) while that additional percentage being shared with other nodes contributes towards giving the enterprise flexibility in planning storage resources and in the goal of effective utilization of enterprise wide storage resources besides other advantages already described.

Additions To Installed Data Storage Capacity

Addition of storage capacity to storage server nodes (SN): If additional data storage capacity is added to storage server nodes (SN) which are a part of the storage segmentation policy, the software agents (SA) on these storage server nodes (SN) automatically configure and segment the additional storage capacity being installed—inline with the existing storage policy.

Addition of storage server nodes (SN): If an additional storage server node (SN) is being added to the network and the storage policy entails configuration, segmentation etc. of all storage resources on the network, the software agents (SA) are automatically and remotely installed by the controller (C) onto the specific storage server node (SN) being added onto the network and its storage resources are configured inline with the existing storage policy.

In either of these situations, when additional storage resources are being brought under the storage policy and in the case of onsite redundancy (where the node manager (NM) is used), the controller (C) checks to ensure that the data storage capacity installed on the node manager (NM) always remains more than the combined storage capacity on the storage server nodes (SN)—as the node manager (NM) has to store as much data as can be stored on all the storage server nodes in addition to the file system metadata on the node manager (NM) itself. So, when more data storage resources are being added, the controller (C) would implement the storage policy only on that many storage resources that would still maintain this condition and temporarily withhold the implementation on the remaining storage resources. However, the controller (C) would notify the storage administrator of this situation and the necessity to increase storage capacity on the node manager (NM). The storage policy would then be implemented on these remaining storage resources i.e. once the storage capacity of the node manager (NM) has been increased.

Business Continuity: As a work around for any possible equipment failure, all the file system metadata (including backups taken) is recorded on the node manager (NM), at an alternate location on the network and at a remote offsite storage location. If the failure occurs on the node manager (NM), business continuity is ensured by setting-up another device with the controller (C) essentially making it a node manager (NM), which can then pick up from the point of interruption.

The methodology and techniques described herein provide several advantages over prior approaches for managing data storage resources in a computing environment. Effective utilization of data storage capacity is accomplished and an avenue is provided to implement an effective data storage policy across or through parts of the network to obtain true value from existing resources and a higher return on investment while putting off/limiting unnecessary expenditure for additional storage resources. The present invention ensures smooth flow of transactions and prevents cessation/hindrance to ongoing business activities due to the mere non-transportability or inability to seamlessly and dynamically share existing data storage resources. A stable and predictable response to rapid increases in demand for storage resources is now achieved with the ability to dynamically tailor this response to match changing requirements.

The present invention enables automatic and dynamic configuration and segmentation of additional data storage resources being added to the network. It also increases network bandwidth usage efficiency by reducing network bandwidth clogging and also effectively utilizes I/O subsystem bandwidth on nodes. Improved data recovery in the event of failure is also facilitated.

Wherever a centralized file server/dedicated storage appliance is used for onsite redundancy, several advantages are offered at no additional cost, by just routing the data path through the same, when necessary.

In the foregoing specification, the invention has been described with reference to an illustrative embodiment thereof. However, it will be evident that various modifications and changes may be made thereto without departing from the broader spirit and scope of the invention. The specification and drawings are, accordingly, to be regarded in an illustrative rather than a restrictive sense. Therefore, it is the object of the appended claims to cover all such modifications and changes as come within the true spirit and scope of the invention.

What is claimed is:

1. A method for effective utilization of data storage capacity using a storage architecture wherein the said storage architecture enables dynamic configuration and segmentation of storage capacity on all or selected nodes on the network system into non-sharable and shared storage capacity segments, said method further based on a percentage of ‘total installed capacity’ or ‘available/unused storage capacity’ on said nodes.

2. A method that uses a centralized file server directly in the path of a distributed network file system, wherein the centralized server acts as a host of original data and also as a back-up device.

3. A method for effective utilization of data storage capacity using a storage architecture wherein the said storage architecture makes optimal utilization of network bandwidth and subsystem I/O bandwidth for storing data in a distributed network file system.
